(19) United States
(12) Patent Application Publication
(10) Pub. No.: US 2013/0064611 A1
(43) Pub. Date: Mar. 14, 2013

(54) DRY DECELERATOR FOR APPLES OR LIKE OBJECTS

(71) Applicants: Alex Kunzler, Issaquah, WA (US); Vincent E. Bryan, JR., Quincy, WA (US); Vincent E. Bryan, III, Mercer Island, WA (US); Pete Kunzler, Issaquart, WA (US); Randy Allard, Issaquart, WA (US); Daniel Baker, Seattle, WA (US)

(72) Inventors: Alex Kunzler, Issaquah, WA (US); Vincent E. Bryan, JR., Quincy, WA (US); Vincent E. Bryan, III, Mercer Island, WA (US); Pete Kunzler, Issaquart, WA (US); Randy Allard, Issaquart, WA (US); Daniel Baker, Seattle, WA (US)

(73) Assignee: Picker Technologies LLC, Mercer Island, WA (US)

(21) Appl. No.: 13/499,487

(22) PCT Filed: Jul. 16, 2010
(86) PCT No.: PCT/US10/38533

§ 371 Date: Jun. 28, 2012

Related U.S. Application Data
(60) Provisional application No. 61/187,102, filed on Jun. 15, 2009.

(51) Int. Cl. B65G 43/00

(52) U.S. Cl. CPC B65G 43/00
USPC 406/83

(57) ABSTRACT

A decelerator device for apples or the like is disclosed. The apples are delivered to the decelerator device by a tube which can be provided with either a positive pressure upstream of the transported objects or a downstream of the transporter device. In one embodiment of the invention, the decelerator is provided with an area of reduced pressure in communication with the distal end of the transport tube. A receiving device such as a plurality of inter-engaged wheels receives the apples of other objects in the area of reduced pressure. The wheels or conveyors receive objects between opposed sealing surfaces, reduce the traveling speed of the object, and transport the object to an area of ambient pressure. The sealing surfaces are disengaged from the transported objects in the area of ambient pressure, and the objects are delivered to a transport path, dry bin, or other desired structure. In another embodiment of the invention, a counter flow of air reduces the speed of the object traveling along the tube.

### BACKGROUND OF THE INVENTION

This application is nationalized from PCT application PCT/US2010/38533 filed Jul. 16, 2010 entitled “Dry Decelerator For Apples or Like Objects”.

This invention relates generally to devices for decelerating objects delivered to the decelerator from a pneumatic or partial vacuum tube of the sort described and claimed in U.S. patent application Ser. No. 12/055,209 filed Mar. 25, 2008 entitled “Transport System For Fruit And Like Objects” now U.S. Pat. No. 7,695,220 and U.S. patent application Ser. No. 12/371,446 filed Feb. 13, 2009 entitled “Mobile System For Improving The Picking And Preliminary Processing Of Apples, Citrus, Stone Fruit And Like Objects” now U.S. Pat. No. 7,882,686. These applications and patents are hereby incorporated herein by reference.

As described in those documents, it has been found advantageous to transport apples, citrus fruit, and stone fruit or like objects through tubes having spaced apart baffles installed therein. These tubes can be provided on a mobile harvester machine or in a packing house or any other desired location. Objects (for example, apples) can be deposited into a distal end of the tube and a partial vacuum created or drawn at the end of the tube proximate to the delivery end of the tube, or within downstream portions of the upstream tube to pull the object through the tube. Alternatively, a positive pressure can be applied to the upstream distal end of the tube or to upstream portions of the tube and, consequently, to the trailing portions of the object being transported to push the object through the tube. In either event, the pressure differential across the object in the tube causes the object to move through the tube with attractive rapidity and reliability.

At the proximal downstream end of the tube, the apple or other object emanating from the tube must be gently decelerated and delivered from the atmospheric environment associated with the tube interior to an ambient atmospheric environment. The handling of the object must be gentle so as not to bruise or otherwise damage the apple or other object.

Decelerators capable of handling objects as described above are described and claimed in co-pending PCT application PCT/US10/021412 filed 19 Jan. 2010 and in U.S. patent application Ser. Nos. 61/145,899 filed Jan. 20, 2009 entitled “Deceleration Tank and Extraction Conveyor” and 61/146,468 filed Jan. 22, 2009 entitled “Multi-Section Decelerator Tank.” These applications are hereby herein incorporated by reference.

It is an object of this invention to provide decelerator mechanisms capable of receiving the apples or other objects emanating from the tubes, to decelerate their movement, and to deliver the apples or like objects to an extraction conveyor or other mechanism.

It is a related object of the invention to provide such a decelerator which will receive objects from the transport tubes in either a positive pressure environment or negative pressure environment, which will decelerate the objects, and which will deliver the objects to an ambient pressure environment without bruising or otherwise harming the objects.

It is a subsidiary object to provide a decelerator which will operate effectively without requiring the objects to be decelerated by immersion in water or other fluids.

Other objects and advantages of the invention will become apparent upon reading the following detailed description and upon reference to the drawings. Throughout the drawings, like reference numerals refer to like parts.

### DESCRIPTION OF THE DRAWINGS

FIG. 1 is a side elevation overview in schematic form of a first embodiment of the invention.

FIG. 2 is a side elevation overview in schematic form of a second embodiment of the invention.

FIG. 2A is a partial sectional view of portions of the invention embodiment shown in FIG. 2, the section being taken substantially in the plane of line 2A-2A in FIG. 2.

FIG. 2B is a partial sectional view of portions of the invention shown in FIG. 2, the section being taken substantially in the plane of line 2A-2A in FIG. 2.

FIG. 3 is a side elevation overview in schematic form of a second embodiment of the invention.

FIG. 3A is a partial sectional view of portions of the invention embodiment shown in FIG. 3, the section being taken substantially in the plane of line 3A-3A in FIG. 3.

FIG. 3B is a partial sectional view of portions of the invention embodiment shown in FIG. 3, the section being taken substantially in the plane of line 3B-3B in FIG. 3.

FIG. 3C is a fragmentary view of a portion of the device shown in FIG. 3 but showing in further detail a portion of the wheel and the seal adjacent the area C in FIG. 3.

FIG. 4 is a side elevation overview in schematic form of a third embodiment of the invention.

FIG. 4A is a partial sectional view of portions of the invention embodiment shown in FIG. 4, the section being taken substantially in the plane of line 4A-4A in FIG. 4.

FIG. 5A is a fragmentary view of the invention embodiment shown in FIG. 4, showing in further detail portions of a decelerator conveyer in FIG. 4.

FIG. 5B is a partial sectional view of portions of the invention embodiment shown in FIG. 5, the section being taken substantially in the plane of 5B-5B in FIG. 5A.

FIG. 6 is a schematic sectional view of a fourth embodiment of the invention.

FIG. 7 is a cut-away isometric view of fifth embodiment of the invention.

FIG. 8 is a cut-away isometric view of the invention shown in FIG. 7 and showing the contemplated paths of travel of objects which have been decelerated by the invention.

FIG. 9 is a cut-away isometric view of a sixth embodiment of the invention illustrating, in schematic form, the path of travel of the decelerated object.

FIG. 10 is a cut-away isometric view of a seventh embodiment of the invention.

FIG. 11 is a schematic view of an eighth embodiment of the invention.

### DETAILED DESCRIPTION

While the invention will be described in connection with several embodiments, it will be understood that it is not intended to limit the invention to these embodiments. On the contrary, it is intended to cover all alternatives, modifications and equivalents as may be included within the spirit and scope of the invention.

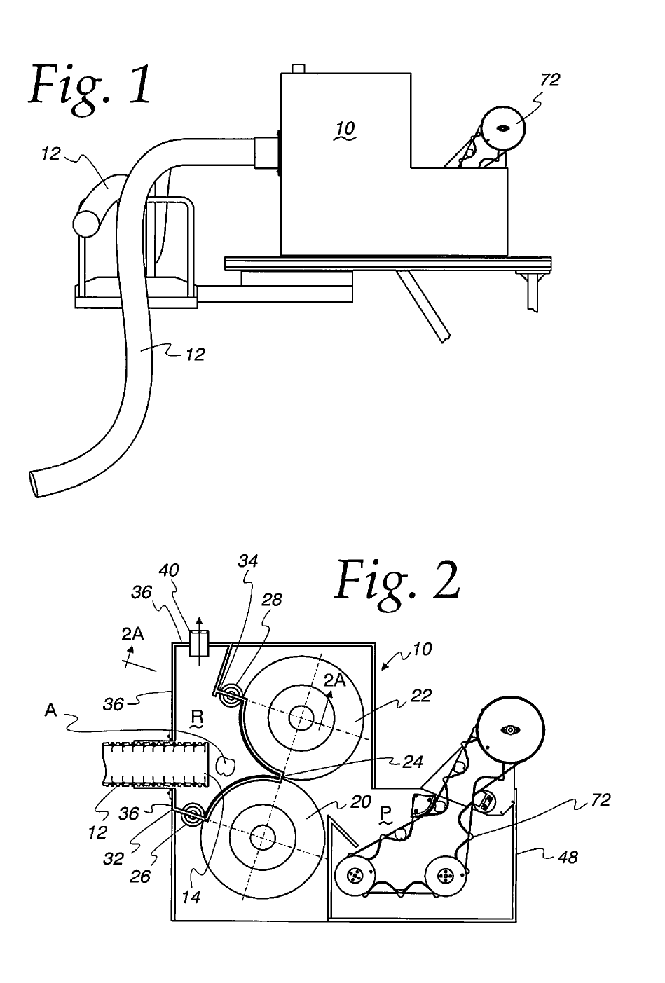

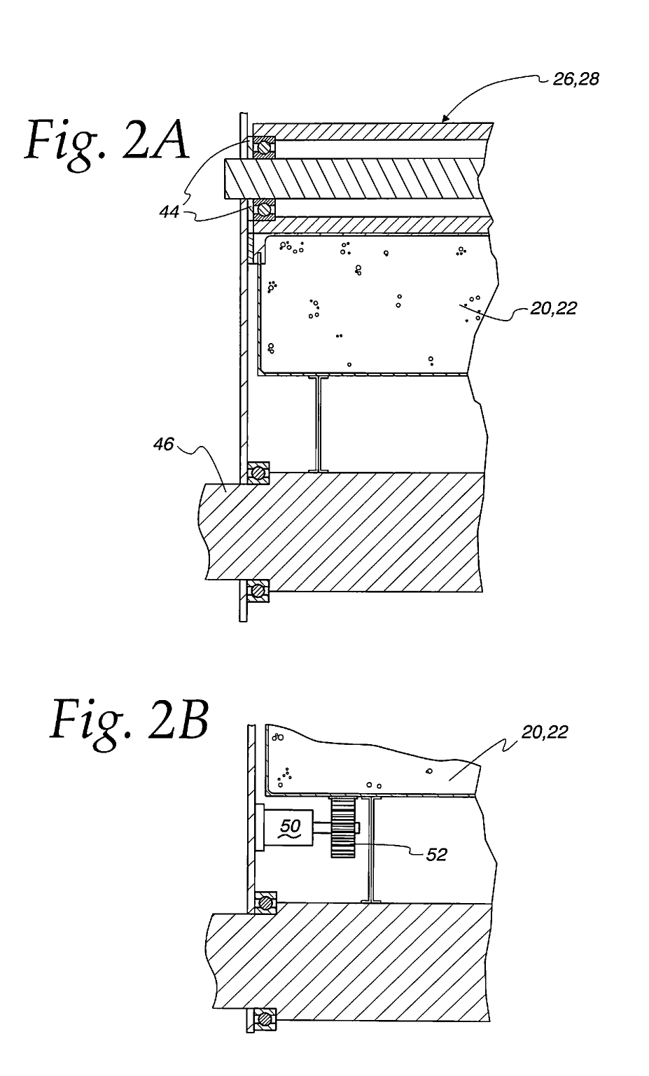

A first embodiment of the invention is shown in FIGS. 1 and 2. Apples A or other objects are transported to the novel decelerator 10 through the pneumatic tubes 12 of the sort described, illustrated and claimed in the above-cited patent and co-pending patent applications. As the apples or other objects emanate from the proximal end 14 of the tube 12, the objects are propelled or fall upon two counter rotating wheels 20, 22. These counter rotating wheels are sized, designed and so positioned as to engage one another with a substantially pressure-tight inter-engagement at a contact area 24. To this end, the wheel rims are provided with deformable materials such as film-covered sponge rubber or other suitable arrangements so as to form the pressure tight seal area 24, yet permit the apple or other emanated object to be engaged and held between the wheels 20, 22 at the area of inter engagement 24 in a generally pressure tight and completely sealed fit.

As shown in FIGS. 1, 1A, 2, 2A and 2B, the wheels 20 and 22 are also engaged by sealing rollers 26 and 28. The sealing rollers 26 and 28 are engaged, in turn, by wiper blades 32 and 34. The associated walls and sides 36 act to provide a three-dimensional space R in which a reduced pressure can be generated by a vacuum exhaust 40. It is this vacuum exhaust and reduced pressure space R which provides the reduced pressure within the tubes 12 to draw or pull the apples or other objects down the tubes 12 and into the space R and, thence, into the engaging and sealing wheel contact area 24. Suitable pressure seals 44 are provided, and a driveshaft 46 rotates the wheels 20, 22 to operate the device. It will be understood that the sealing walls and sides 36 are open at the point of inter-wheel seal contact to permit the apples or other objects to pass out of the area of reduced pressure R and into the sealing wheel contact area 24.

An alternate mechanism for driving the wheels 20, 22 is shown in FIG. 1B. Here a motor 50 having a suitable gear drive system 52 is provided to drive the wheels 20, 22.

Apples or other objects emanating from the area of pressure sealing inter-engagement 24 enter in an area P of ambient pressure, and the objects A can fall or tumble gently into a receiving and extraction conveyor 72.

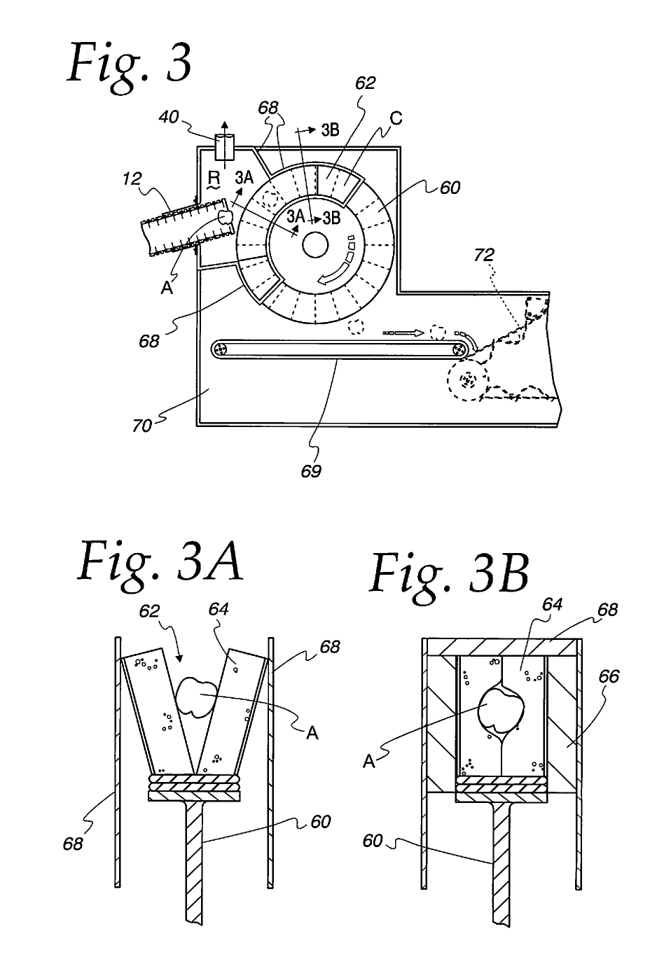

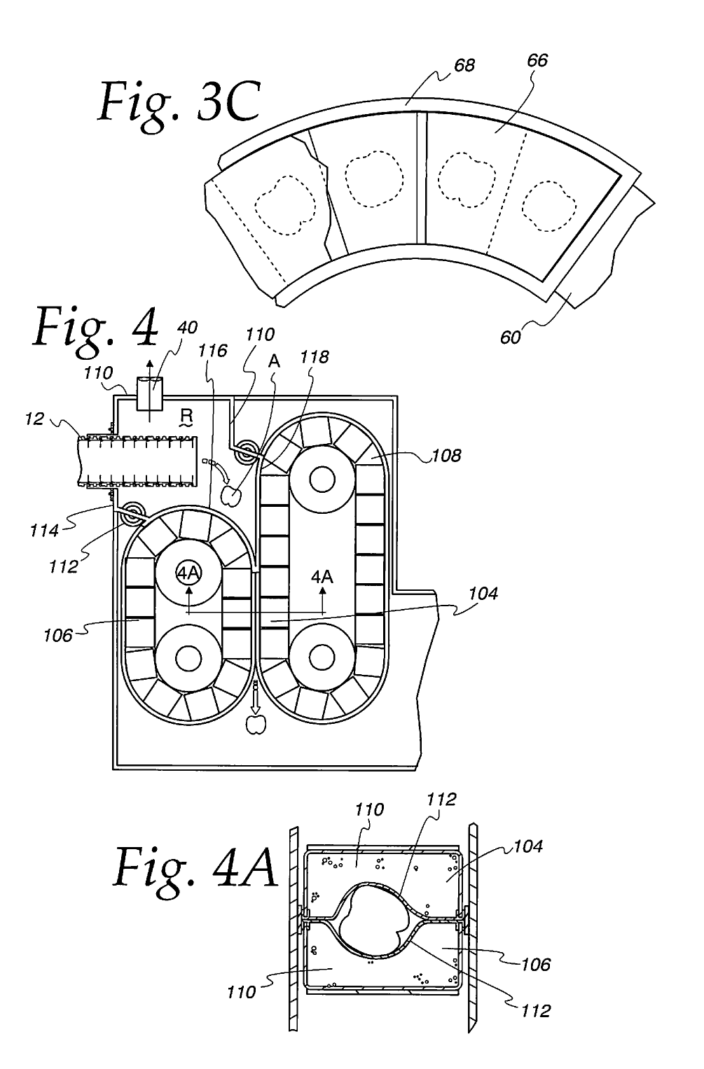

A second embodiment of the invention is shown in FIG. 3. Here the tube 12 delivers the apples A or other objects to a rotating wheel 60. This wheel 60 is provided with a rim 62 comprising normally open or V-configured sponge rubber or other deformable material 64 as shown in FIG. 3A. The delivered apples are engaged and transported along a curved wheel path by the wheel 60. As the wheel rotates, this open or V-shaped rim is axially compressed so that the deformable material 64 completely closes around the apple or other object as shown in FIG. 3B with a pressure-tight seal. This closing action is caused by closing cams 66. These cams can be stationary guides, or they can be arranged as endless belts which push in an axial direction against the wheel rim sides. Stationary seals 68 here define in the area of reduced pressure R; air pressure within this area R is reduced to a partial vacuum by a suitable vacuum draw system 40.

As the wheel 60 rotates and the apples turn out of the rim compression zone C, the wheel rim 62 reopens from the configuration shown in FIG. 3B to the configuration shown in FIG. 3A. The apples then drop or otherwise gently tumble into a receiving bin which can be dry, or the apples can be gently dropped onto a transfer conveyor 69 for transportation to and extraction conveyor 72 of the type described in U.S. patent application Ser. No. 61/145,899 filed Jan. 20, 2009 and entitled “Deceleration Tank And Extraction Conveyor” and follow-on PCT International Application No. PCT/US10/021412 filed Jan. 19, 2010 entitled “Decelerator Comprising Deceleration Tank and Extraction Conveyor” claiming priority therefrom.

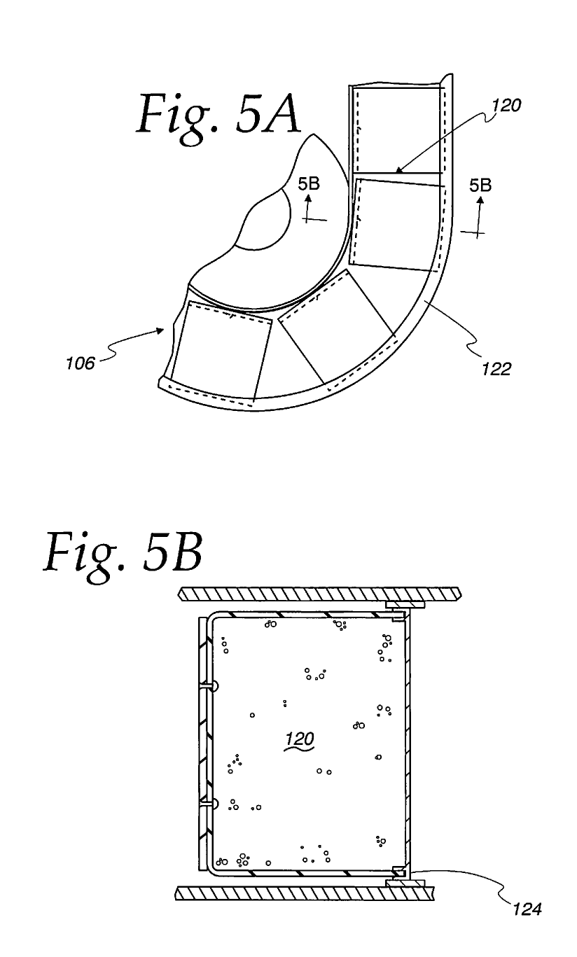

Yet another embodiment of the invention is shown in FIGS. 4, 4A, 5A and 5B. Here, the apples A emanating from the delivery tube 12 are directed to an inter-engagement pressure-sealing area 104 formed between two elongated, endless conveyors 106 and 108. Again, suitable walls 110, wiper rollers 112 and wiper blades 114, together with sealing surfaces 116, 118 provide an area R of reduced pressure; the pressure within the area R can be reduced by any suitable vacuum generator 40.

An apple A engaged by, and pressure-sealed between, the conveyors 104 and 106 is shown in FIG. 4A. Deformable material 110 can form the peripheries of the two conveyors, and the surfaces of these materials can be provided with pliable airtight films or other seals 112, if desired.

As shown in FIGS. 5A and 5B, the conveyer 106 can take the form of a series of pads 120 which can be provided with soft material to receive the apples or other objects. A sealing membrane belt 122 surrounding the pads 120 can provide the requisite pressure seal. Crescent seals 124 of known construction can provide additional sealing as required.

In general terms, each of the foregoing embodiments of the invention operates in a somewhat similar manner. The objects such as apples A are provided to the decelerator at the end of a pneumatic or other fluid tube. The objects emanate from that tube at a velocity which can vary from time to time and from object to object. The emanating objects are engaged by one or more moving, endless, padded decelerator bodies such as a wheel or inter-engaged counter-rotating wheels. The object can be engaged by a conveyor or by a series of inter-engaged conveyors

If desired, one or more of these padded wheels, padded conveyors or other handling mechanisms can have a slower peripheral speed than the initial velocity of the arriving object. In other terms, the traveling speed of the pneumatically delivered object can be reduced, if desired, to the peripheral speed of the decelerator wheel or other body.

The fruit or other object is enclosed and is compressively engaged in a substantially air-tight fit by one or more decelerator wheels, conveyors or similarly arrayed decelerator devices. When so engaged, the decelerating object passes from an area of either reduced or elevated air pressure to a region of ambient air pressure. Finally, the decelerated object, now in a region of ambient pressure, is released from its air-tight fit within or upon the decelerator device and is delivered to a downstream site such as a transfer conveyor, receiving bin, or other object handler.

FIG. 6 illustrates a fourth embodiment of the invention. Here, no wheels, conveyors or other endless moving elements are involved. Rather, the transport tube 12 is provided with a series of spaced apart baffles 132-136 as disclosed in U.S. Pat. No. 7,695,220. As disclosed in that '220 patent, each of these baffles is provided with an aperture which can be circular, polygonal, or of any other effective shape. As the object A travels along the tube, it is momentarily engaged by and then passes through each baffle. This momentary engagement by the baffle permits a pressure differential to be developed across the object; the pressure on the forward side of the object becomes less than the air pressure on the rear side of the object and the object is forced through the baffle with momentum sufficient to cause the object to engage the next succeeding baffle in the tube 12.

In accordance with the invention herein, the series of baffles 133-136 at the delivery end 140 of the tube 12 are provided with apertures 142-146 of progressively larger sizes. As the object A travels through these baffles, the pressure differential across the object A becomes progressively less, and so the object is urged along the tube with progressively less momentum and speed. If desired, the object A is simply and gently released from the distal end 140 of the tube 12. If desired, a suitable airlock mechanism of known design (not shown) can be provided to transfer the object to an extraction conveyor of any convenience sort.

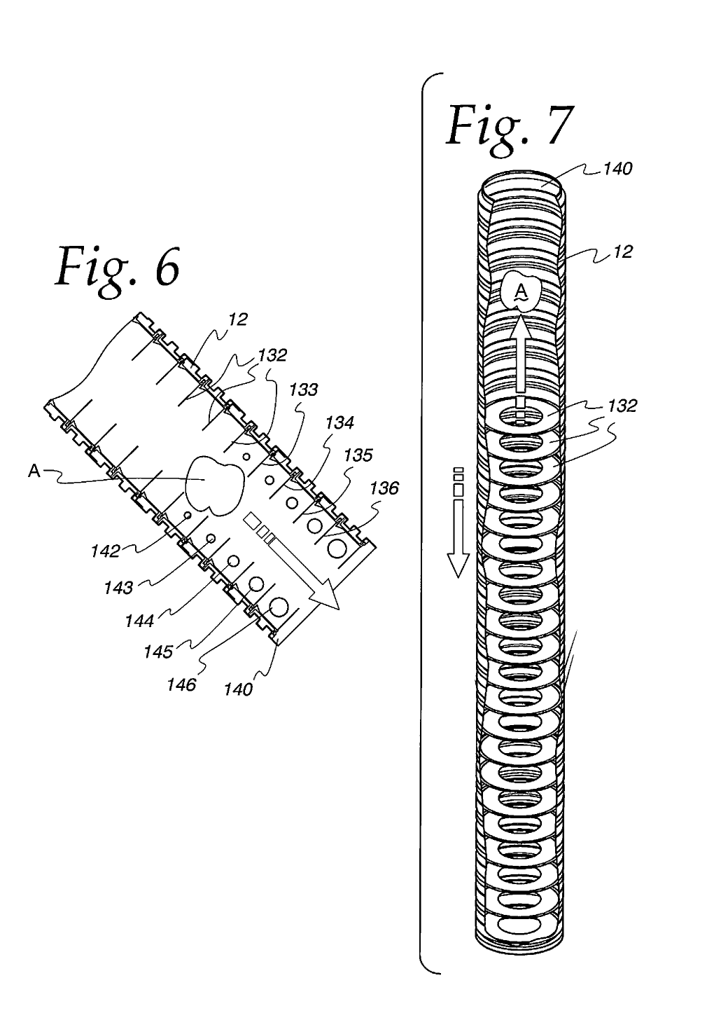

As shown in FIG. 7, the portions of the transport tube 12 adjacent to the distal end 140 can be positioned so that the object A is traveling in a substantially upward direction. Baffles can be eliminated from that portion of the adjacent the delivery end 140 so that gravity slows the traveling speed of the object A to a desired and manageable velocity. Again, a suitable airlock mechanism of known design (not shown) and/or an extraction conveyor of any convenient sort can be provided adjacent that distal or delivery tube end 140.

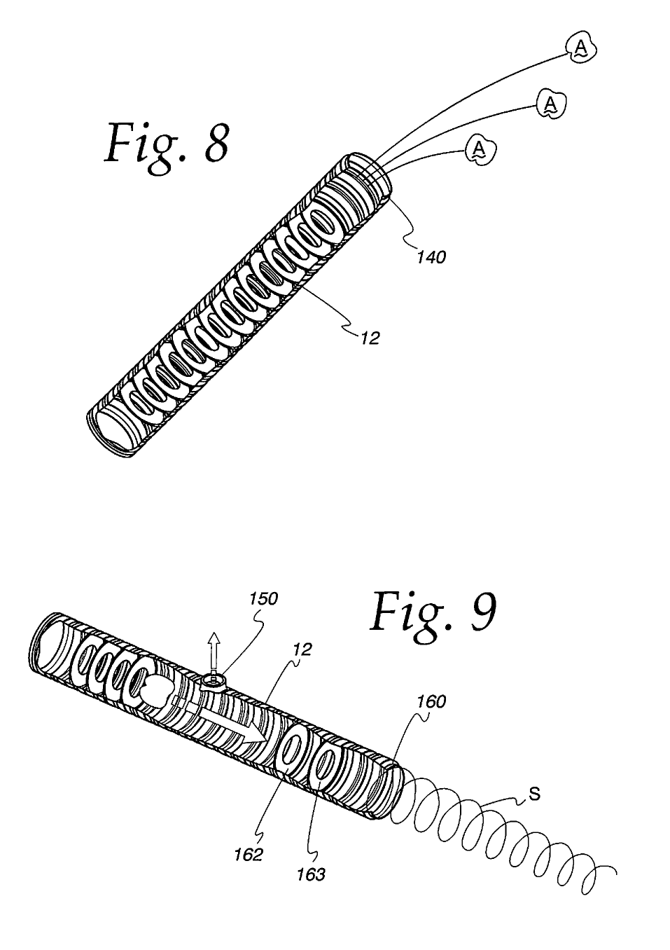

As shown in FIG. 8, that portion of the tube 12 which is adjacent the object delivery end 140 can be positioned in a diagonally upwardly and outwardly extending direction so that the emanating objects are simply tossed out, or pop out, of the tube into any known receiving device. The device could be, for example, a trough conveyor, catchment containers such as bags, bins, brushes, wheels provided with cup catchers, or any other suitable device of known design.

FIG. 9 shows a sixth embodiment of the invention. Here the tube 12 is provided with a vacuum source 150 at a position located intermediate the ends of the tube and at some distance from the distal end or delivery open end 160 of the tube.

Accordingly, air flows into the tube from the end 160 toward the tube evacuation point 150, in the opposite direction of travel of the object A. This counter-flow of air slows the momentum of the traveling object A. If desired, a number of baffles 162, 163 can be positioned to further engage and further slow the travel of the object A. As indicated by the spiral line S, the object A can tumble or spin as it moves through and out of the tube 12.

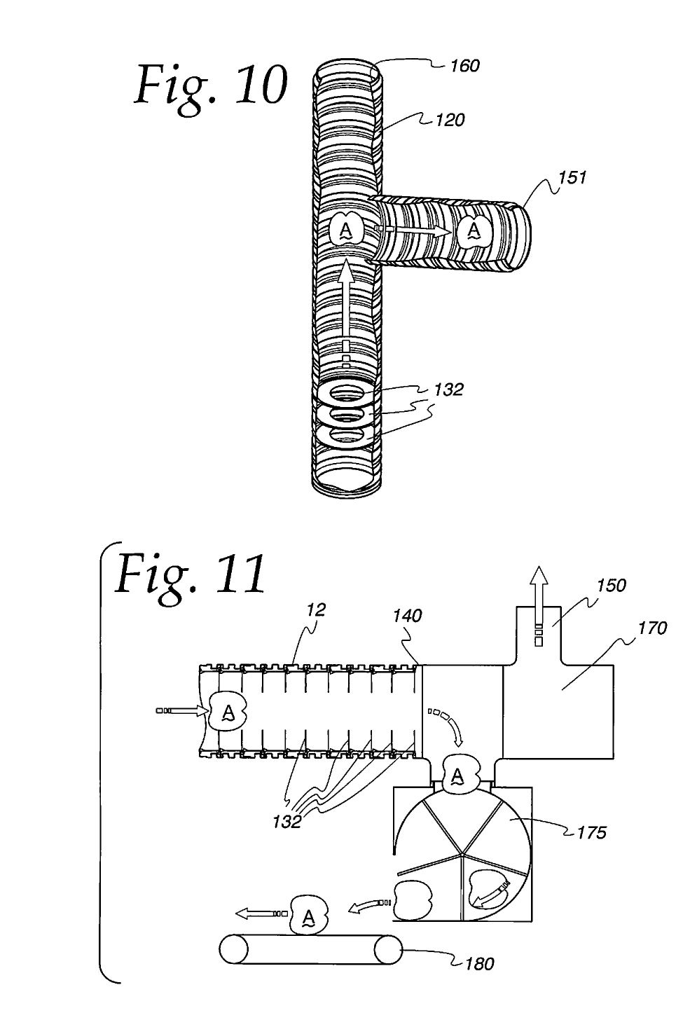

FIG. 10 shows a seventh embodiment of the invention. Here, the vacuum is drawn through the base 151 of a T-shaped tube array, and so the travel of the object A is diverted down this base 151. Again, air flowing into the tube through the end 160 confronts the object and slows its momentum.

FIG. 11 shows an eighth embodiment of the invention. Here the object A travels along the tube 12 to its delivery end 140, and the vacuum generator 150 is located at a position beyond the tube end 140. If desired, an abutment screen 170 can be provided to affirmatively halt object travel. The object A then falls into a convenient device such as a rotating vane wheel 175 for delivery to a transfer conveyor 180.

The following is claimed as invention:

1. A decelerator device, comprising, in combination:
an area of non-ambient reduced or enhanced pressure for receiving traveling objects from a delivery tube; and
receiving means for receiving the objects from the delivery tube, for slowing the speed of the traveling objects, and for delivering the object to an area of ambient pressure.

2. The device according to claim 1 wherein said receiving means includes means for carrying the object past pressure-tight seals.

3. The device according to claim 1 wherein said receiving means comprises a plurality of inter-engaged wheels.

4. The device according to claim 1 wherein the receiving means includes a transport device having a deformable and reformable rim.

5. A device according to claim 4 wherein said transport device comprises a wheel.

6. A device according to claim 1 wherein said transport device comprises a wheel having padded vanes.

7. A device according to claim 1 wherein said vanes are adapted to inter-engage one another to form a substantially complete sealing surface.

8. A device according to claim 1 wherein said receiving device comprises at least two endless conveyors positioned with respect to one another so as to provide an elongated area of mutual inter-engagement.

9. A method of decelerating objects emanating from a delivery tube into an area of non-ambient reduced or enhanced pressure comprising the steps of:
engaging the emanating object within the area of reduced or enhanced pressure;
sealing the object in a substantially pressure-tight environment;
delivering the sealed object to an area of ambient pressure; and
unsealing the object in the area of ambient pressure.

10. A method according to claim 9 wherein the sealing step is performed between a plurality of wheels having mutually inter-engaged peripheries.

11. A method for decelerating fruit or other objects delivered from a pneumatic delivery tube, comprising the steps of:
providing an object decelerator in pneumatic connection with a pneumatic object delivery tube;
delivering an object from the tube to the decelerator;
engaging the delivered object with a substantially airtight fit by a decelerator mechanism within the decelerator;
transferring the engaged object from a region of non-ambient reduced or enhanced air pressure to an area of ambient air pressure while the object is so engaged; and
releasing the decelerated object from the decelerator mechanism into the region of ambient air pressure.

12. A decelerator system for decelerating objects traveling through a pneumatic tube having a series of baffles installed therein, the tube having an upstream end for receiving objects and a downstream end for discharging objects, the decelerator system comprising:
a first vacuum source connected to the tube for withdrawing air from the tube at a first point intermediate the tube ends and;
a second vacuum source connected to the tube for withdrawing air from the tube at a second point downstream from the first vacuum source;
and operating so as to provide a flow of air from the second vacuum source toward the first vacuum source in a direction opposite to the direction of travel of the objects in the tube.

13. A decelerator system for decelerating objects traveling through a pneumatic tube having a series of baffles installed therein, the tube having an upstream end for receiving objects, and a downstream end for discharging objects, the decelerator system comprising:
a series of apertured baffles affixed within the tube at spaced apart intervals and adapted to at least momentarily engage an object traveling through the tube so as to encourage the formation of a pressure differential between the forward surface of the object and the rear surface of the object; and
at least one of the baffles defining an aperture larger than the aperture defined in a preceding baffle so as to progressively lessen the pressure differential across the object and thereby slow the travel of the object through the tube.

14. A decelerator system for decelerating objects traveling through a pneumatic tube, the tube having an air pressure therein other than an ambient pressure, the decelerator system comprising:
a housing having a hollow interior;
at least one sealing member dividing the housing interior into a first region communicating with the pneumatic tube and having therein an air pressure other than an ambient pressure, and a second region in the housing interior having therein an ambient air pressure; and
at least one endless transport means extending from the first region to the second region and adapted to receive the objects in the first region, at least partially seal the objects in an airtight grip, transport the objects into the second region, and there discharge the objects in the second region.

15. A decelerator system according to claim 14 wherein said endless transport means includes at least one wheel.

16. A decelerator system according to claim 14 wherein said endless transport means includes at least two inter engaged counter rotating wheels adapted to form an air pressure seal at the area of mutual inter-engagement.

17. A decelerator system according to claim 14 wherein said endless transport means includes at least two elongated, inter-engaged counter rotating conveyors adapted to form an air pressure seal at the area of mutual inter-engagement.
